(19) United States
(12) Patent Application Publication
(10) Pub. No.: US 2016/0073398 A1
(43) Pub. Date: Mar. 10, 2016

(54) METHODS AND APPARATUS FOR PAGING PERFORMANCE IMPROVEMENT USING TIMING INFORMATION UPDATE IN MULTI-SIM-MULTI-STANDBY USER EQUIPMENT

(71) Applicant: QUALCOMM Incorporated, San Diego, CA (US)

(72) Inventors: Bhaskara Viswanadham Batchu, Medak (IN); Soumen Mitra, Hyderabad (IN); Jun Hu, San Diego, CA (US)

(21) Appl. No.: 14/478,370

(22) Filed: Sep. 5, 2014

(51) Int. Cl. H04W 72/04; H04W 24/04; H04W 68/02

(52) U.S. Cl. CPC H04W 72/0446; H04W 68/02; H04W 24/04; H04W 88/06

(57) ABSTRACT

Methods and apparatus for of tracking network system timing are provided. In one aspect, a method for updating system timing information comprises determining a first periodicity of a plurality of first windows for a first radio access technology of a user equipment to access a radio frequency chain of the user equipment. The method further includes identifying a time between the plurality of first windows for a second radio access technology of the user equipment to access the radio frequency chain. The method further includes allocating a portion of the time between the first windows for the second radio access technology to update timing information of the second radio access technology.

### BACKGROUND

1. Field

Certain aspects of the present disclosure generally relate to wireless communication systems, and more particularly, to methods and apparatus for paging performance improvement using timing information update in Multi-SIM-Multi-Standby User Equipment.

2. Background

In many telecommunication systems, communications networks are used to exchange messages among several interacting spatially-separated devices. In some implementations, a user equipment (UE) may be configured to communicate utilizing more than one communication protocol utilizing more than one radio access technology (RAT). Such devices may be known as Multi-SIM devices. When managing the UE's access to more than one RAT, it may become necessary to tune the transmit chain and the receive chain of the UE's transceiver for transmitting and/or receiving, respectively, at frequencies associated with either a first RAT or with a second RAT. Occasionally, a first RAT may attempt to access the radio frequency (RF) chain of the UE's transceiver but the second RAT may have priority over the first RAT and the first RAT may not be able to access the RF chain for an extended amount of time. The first RAT may then lose timing information which may force a system restart that consumes a large amount of power and time. Accordingly, there is a need for methods and apparatuses for performing efficient timing information updates in Multi-SIM devices.

### SUMMARY

Various implementations of systems, methods and devices within the scope of the appended claims each have several aspects, no single one of which is solely responsible for the desirable attributes described herein. Without limiting the scope of the appended claims, some prominent features are described herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

One aspect of the disclosure provides a method for updating system timing information. The method includes determining a first periodicity of a plurality of first windows for a first radio access technology of a user equipment to access a radio frequency chain of the user equipment. The method further includes identifying a time between the plurality of first windows for a second radio access technology of the user equipment to access the radio frequency chain. The method further includes allocating a portion of the time between the first windows for the second radio access technology to update timing information of the second radio access technology.

Another aspect of the disclosure provides an apparatus for wireless communication. The apparatus includes a radio frequency chain. The apparatus further includes a first subscriber identity module (SIM) providing a first radio access technology. The apparatus further includes a second subscriber identity module (SIM) providing a second radio access technology. The apparatus further includes a processor configured to determine a first periodicity of a plurality of first windows for the first radio access technology to access the radio frequency chain. The processor further configured to identify a time between the plurality of first windows for the second radio access technology to access the radio frequency chain. The processor further configured to allocate a portion of the time between the first windows for the second radio access technology to update timing information of the second radio access technology.

Another aspect of the disclosure provides an apparatus for wireless communication. The apparatus includes means for communicating over a first radio access technology. The apparatus further includes means for communicating over a second radio access technology. The apparatus further includes means for determining a first periodicity of a plurality of first windows for the first radio access technology to access a radio frequency chain of the apparatus. The apparatus further includes means for identifying a time between the plurality of first windows for the second radio access technology to access the radio frequency chain. The apparatus further includes means for allocating a portion of the time between the first windows for the second radio access technology to update timing information of the second radio access technology.

Another aspect of the subject matter described in the disclosure provides a non-transitory computer-readable medium including code that, when executed, causes a wireless communication apparatus to determine a first periodicity of a plurality of first windows for a first radio access technology of a user equipment to access a radio frequency chain of the user equipment. The medium further includes code that, when executed, causes the apparatus to identify a time between the plurality of first windows for a second radio access technology of the user equipment to access the radio frequency chain. The medium further includes code that, when executed, causes the apparatus to allocate a portion of the time between the first windows for the second radio access technology to update timing information of the second radio access technology.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 is a time sequence diagram of an exemplary RF chain and 1× request for page decode.

FIG. 4 is a time sequence diagram of an exemplary RF chain and 1× request for page decode using an updated timing information wake-up.

FIG. 5 is a flow chart of an exemplary method for updating system timing information.

FIG. 6 is a functional block diagram of an apparatus that can be employed to perform a method of FIG. 6 in the wireless communication system of FIG. 1.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000 1× (“1×”), etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art.

It should be emphasized that the disclosed techniques may also be applicable to technologies and the associated standards related to LTE Advanced, LTE, W-CDMA, TDMA, OFDMA, High Rate Packet Data (HRPD), Evolved High Rate Packet Data (eHRPD), Worldwide Interoperability for Microwave Access (WiMax), GSM, enhanced data rate for GSM evolution (EDGE), and so forth. Terminologies associated with different technologies can vary. For example, depending on the technology considered, the User Equipment (UE) used in UMTS can sometimes be called a mobile station, a user terminal, a subscriber unit, an access terminal, etc., to name just a few. Likewise, Node B used in UMTS can sometimes be called an evolved Node B (eNodeB), an access node, an access point, a base station (BS), HRPD base station (BTS), and so forth. It should be noted here that different terminologies apply to different technologies when applicable.

In some implementations, a WLAN includes various devices which are the components that access the wireless network. For example, there can be two types of devices: access points (“APs”) and clients (also referred to as stations, or “STAs”). In general, an AP can serve as a hub or base station for the WLAN and a STA serves as a user of the WLAN. For example, a STA can be a laptop computer, a personal digital assistant (PDA), a mobile phone, a wearable computing device (e.g., a watch), an appliance, a sensor, a vending machine, etc. In an example, a STA connects to an AP via a WiFi (e.g., IEEE 802.11 protocol) compliant wireless link to obtain general connectivity to the Internet or to other wide area networks. In some implementations a STA can also be used as an AP.

An access point (“AP”) can also include, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” can also include, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal can include a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device or wireless device connected to a wireless modem. Accordingly, one or more aspects taught herein can be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

Wireless devices, such as a group of STAs, for example, can be used for neighborhood aware networking (NAN), or social-WiFi networking. For example, various stations within the network can communicate on a wireless device to wireless device (e.g., peer-to-peer communications) basis with one another regarding applications that each of the STAs supports. It is desirable for a discovery protocol used in a social-WiFi network to enable STAs to advertise themselves (e.g., by sending discovery packets) as well as discover services provided by other STAs (e.g., by sending paging or query packets), while ensuring secure communication and low power consumption. It should be noted that a discovery packet can also be referred to as a discovery message or a discovery frame. It should also be noted that a paging or query packet can also be referred to as a paging or query message or a paging or query frame.

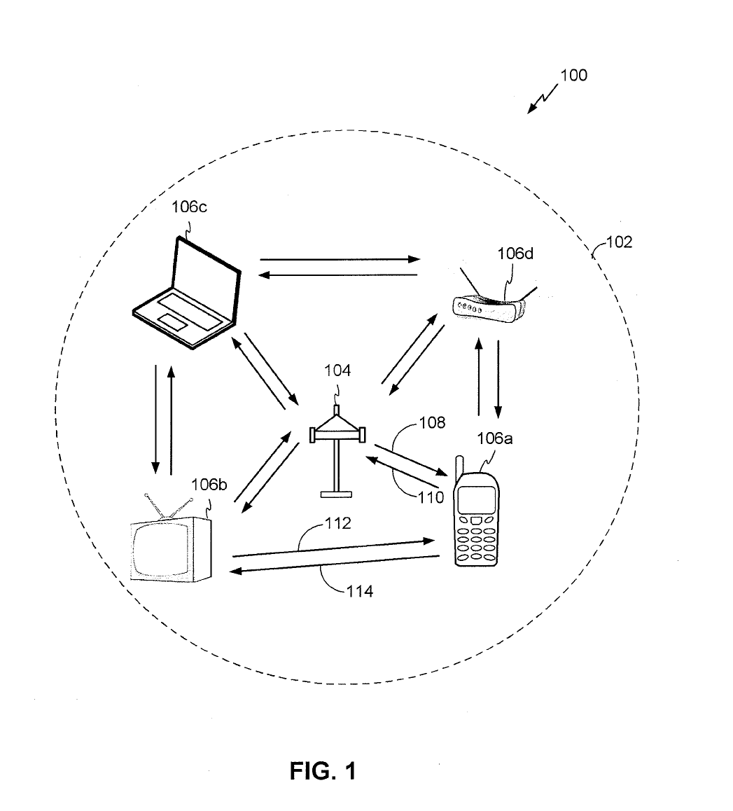

FIG. 1 illustrates an example of a wireless communication system 100 in which aspects of the present disclosure can be employed in accordance with an embodiment. The wireless communication system 100 can operate pursuant to a wireless standard, such as an 802.11 standard. The wireless communication system 100 can include an AP 104, which communicates with STAs 106. In some aspects, the wireless communication system 100 can include more than one AP. Additionally, the STAs 106 can communicate with other STAs 106. As an example, a first STA 106a can communicate with a second STA 106b. As another example, a first STA 106a can communicate with a third STA 106c although this communication link is not illustrated in FIG. 1.

A variety of processes and methods can be used for transmissions in the wireless communication system 100 between the AP 104 and the STAs 106 and between an individual STA, such as the first STA 106a, and another individual STA, such as the second STA 106b. For example, signals can be sent and received in accordance with OFDM/OFDMA techniques. If this is the case, the wireless communication system 100 can be referred to as an OFDM/OFDMA system. Alternatively, signals can be sent and received between the AP 104 and the STAs 106 and between an individual STA, such as the first STA 106a, and another individual STA, such as the second STA 106b, in accordance with CDMA techniques. If this is the case, the wireless communication system 100 can be referred to as a CDMA system.

A communication link that facilitates transmission from the AP 104 to one or more of the STAs 106 can be referred to as a downlink (DL) 108, and a communication link that facilitates transmission from one or more of the STAs 106 to the AP 104 can be referred to as an uplink (UL) 110. Alternatively, a downlink 108 can be referred to as a forward link or a forward channel, and an uplink 110 can be referred to as a reverse link or a reverse channel.

A communication link can be established between STAs, such as during social-WiFi networking in a NAN. Some possible communication links between STAs are illustrated in FIG. 1. As an example, a communication link 112 can facilitate transmission from the first STA 106a to the second STA 106b. Another communication link 114 can facilitate transmission from the second STA 106b to the first STA 106a.

The AP 104 can act as a base station and provide wireless communication coverage in a basic service area (BSA) 102. The AP 104 along with the STAs 106 associated with the AP 104 and that use the AP 104 for communication can be referred to as a basic service set (BSS). It should be noted that the wireless communication system 100 may not have a central AP 104, but rather can function as a peer-to-peer network between the STAs 106. Accordingly, the functions of the AP 104 described herein can alternatively be performed by one or more of the STAs 106.

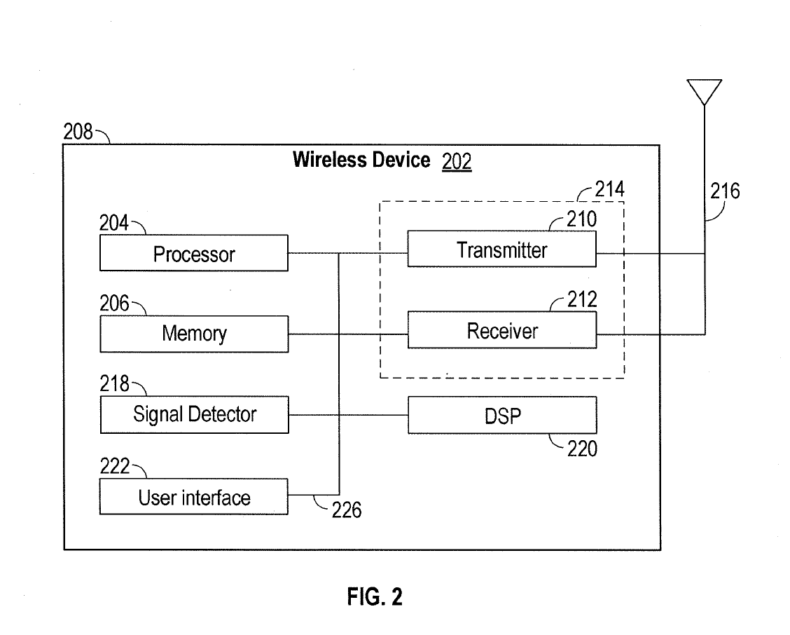

FIG. 2 illustrates various components that can be utilized in a wireless device 202 that can be employed within the wireless communication system 100 in accordance with an embodiment. The wireless device 202 is an example of a wireless device that can be configured to implement the various methods described herein. For example, the wireless device 202 can comprise the AP 104 or one of the STAs 106.

The wireless device 202 can include a processor 204 which controls operation of the wireless device 202. The processor 204 can also be referred to as a central processing unit (CPU). Memory 206, which can include both read-only memory (ROM) and random access memory (RAM), can provide instructions and data to the processor 204. A portion of the memory 206 can also include non-volatile random access memory (NVRAM). The processor 204 typically performs logical and arithmetic operations based on program instructions stored within the memory 206. The instructions in the memory 206 can be executable to implement the methods described herein.

The processor 204 can comprise or be a component of a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system can also include machine-readable media for storing software. Software shall be construed broadly to mean any type of instructions, whether referred to as software, firmware, middleware, microcode, hardware description language, or otherwise. Instructions can include code (e.g., in source code format, binary code format, executable code format, or any other suitable format of code). The instructions, when executed by the one or more processors, cause the processing system to perform the various functions described herein.

The wireless device 202 can also include a housing 208 that can include a transmitter 210 and/or a receiver 212 to allow transmission and reception of data between the wireless device 202 and a remote location. The transmitter 210 and receiver 212 can be combined into a transceiver 214. An antenna 216 can be attached to the housing 208 and electrically coupled to the transceiver 214. The wireless device 202 can also include (not shown) multiple transmitters, multiple receivers, multiple transceivers, and/or multiple antennas.

The transmitter 210 can be configured to wirelessly transmit packets having different packet types or functions. For example, the transmitter 210 can be configured to transmit packets of different types generated by the processor 204. When the wireless device 202 is implemented or used as an AP 104 or STA 106, the processor 204 can be configured to process packets of a plurality of different packet types. For example, the processor 204 can be configured to determine the type of packet and to process the packet and/or fields of the packet accordingly. When the wireless device 202 is implemented or used as an AP 104, the processor 204 can also be configured to select and generate one of a plurality of packet types. For example, the processor 204 can be configured to generate a discovery packet comprising a discovery message and to determine what type of packet information to use in a particular instance.

The receiver 212 can be configured to wirelessly receive packets having different packet types. In some aspects, the receiver 212 can be configured to detect a type of a packet used and to process the packet accordingly.

The wireless device 202 can also include a signal detector 218 that can be used in an effort to detect and quantify the level of signals received by the transceiver 214. The signal detector 218 can detect such signals as total energy, energy per subcarrier per symbol, power spectral density and other signals. The wireless device 202 can also include a digital signal processor (DSP) 220 for use in processing signals. The DSP 220 can be configured to generate a packet for transmission. In some aspects, the packet can comprise a physical layer data unit (PPDU).

The wireless device 202 can further comprise a user interface 222 in some aspects. The user interface 222 can comprise a keypad, a microphone, a speaker, and/or a display. The user interface 222 can include any element or component that conveys information to a user of the wireless device 202 and/or receives input from the user. The wireless device can further comprise a battery (not shown) to power the wireless device.

The various components of the wireless device 202 can be coupled together by a bus system 226. The bus system 226 can include a data bus, for example, as well as a power bus, a control signal bus, and a status signal bus in addition to the data bus. The components of the wireless device 202 can be coupled together or accept or provide inputs to each other using some other mechanism.

Although a number of separate components are illustrated in FIG. 2, one or more of the components can be combined or commonly implemented. For example, the processor 204 can be used to implement not only the functionality described above with respect to the processor 204, but also to implement the functionality described above with respect to the signal detector 218 and/or the DSP 220. Further, each of the components illustrated in FIG. 2 can be implemented using a plurality of separate elements.

Occasionally, a RAT may attempt to access the radio frequency (RF) chain of the UE's transceiver but another RAT may have priority over the RAT and the RAT may not be able to access the RF chain for an extended amount of time. The RAT may then lose timing information which may force a system restart that consumes a large amount of power and time. Embodiments described herein relate to paging performance improvement in Multi-SIM-Multi-Standby devices with Multiple RATs (cdma 2000 1×, GSM, LTE etc.) co-existing. Though embodiments described herein generally describe 1× paging, such implementations may apply to other RAT access and/or paging.

In some embodiments, a UE may be operating in Multi-SIM-Multi-Standby mode. A first RAT (e.g., GSM, LTE, high data rate (HDR), etc.) may be performing cell reselection, or may be in an access state, in a highly faded channel condition. During these times, the first RAT reserves the RF chain of the UE with a higher priority than a second RAT (e.g., 1×). Additionally, in highly faded channels the first RAT may hold the RF chain for a large amount of time. In some embodiments, the second RAT may attempt to access the RF chain (e.g., to perform a page decode) and may fail to access the RF chain because it is in use by the first RAT. In some embodiments, the second RAT attempts to access the RF chain and update its timing information with a scheduled periodicity. When the first RAT fails to access the RF chain for a certain amount of time it may perform a system restart and may begin searching for a new or better system. The system restart may cause a brief outage of the first RAT service and the first RAT paging performance may be severely degraded.

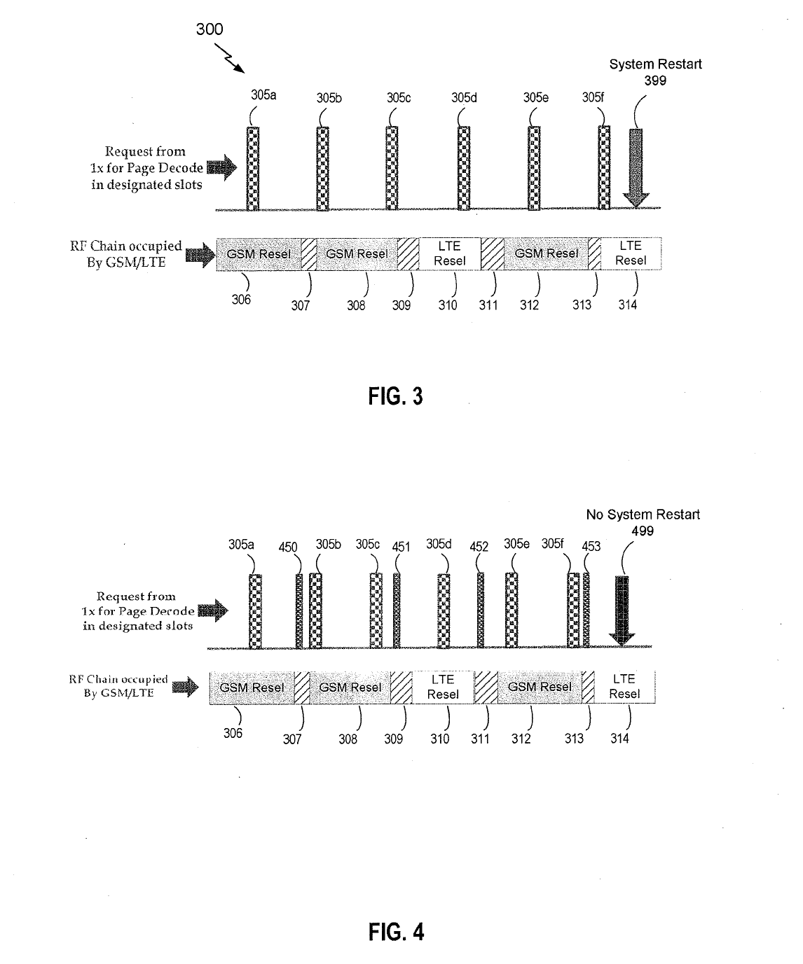

FIG. 3 is a time sequence diagram 300 of an exemplary RF chain and 1× request for page decode. As shown, the first RAT (1×) attempts to access the RF chain to perform a 1× page decode at periodic times 305a-f. Additionally, other RATs (GSM and LTE) with higher priority than the 1×RAT occupy the RF chain during the times 306, 308, 310, 312, 314 which include the times 305a-f. During times 307, 309, 311, 313, the RF chain is not occupied by any RAT. For example, at time 305c, the 1× network (first RAT) attempts to access the RF chain but it is occupied by the GSM network during the time 308 which includes the time 305c. When the GSM releases the RF chain, and the RF chain is free during time 309, the RF chain is not given to the 1× network because time 309 is outside of the 1× designated wake up times (e.g., times 305). Instead the RF chain is given to the LTE network during time 310 and when the 1× network attempts to access the RF chain at time 305d, the RF chain is occupied and denies the 1× access request. As shown, first RAT (1×) then is not able to access the RF chain at times 305a-f, and at time 399, after a number for failed attempts, it performs a system restart as described above.

FIG. 4 is a time sequence diagram 400 of an exemplary RF chain and 1× request for page decode using an updated timing information wake-up. The time sequence diagram 400 illustrated in FIG. 4 is similar to and adapted from the time sequence diagram 300 illustrated in FIG. 3. Elements common to both share common reference indicia, and only differences between the systems 300 and 400 are described herein for the sake of brevity.

The second RAT (GSM and LTE) reselection occurring during times 306, 308, 310, 312, 314 may be periodic. As described above, the RF chain is released in between two consecutive attempts of GSM/LTE cell reselection (or HDR Access) during times 307, 309, 311, and 313. The first RAT (1×) page decode attempts are also periodic and occur during the times 305a-f. However, in some embodiments, the first RAT may determine that the RF chain is free during the times 307, 309, 311, 313 and may perform a forced wake-up to access the RF chain and perform a timing information update.

In FIG. 4, the first RAT (1×) performs the forced wake-ups at times 450, 451, 452, 453 which are outside of the times 305a-f and within the times 307, 309, 311, 313, respectively. For example, at time 305c, the 1× network (first RAT) attempts to access the RF chain but it is occupied by the GSM network during the time 308 which includes the time 305c. When the GSM releases the RF chain, and the RF chain is free during time 309, the 1× network (first RAT) requests access (e.g., performs a forced wake-up) to the RF chain. Since the RF chain is unoccupied, the RF chain is given to the 1× network outside of the 1× designated wake up times (e.g., times 305) during time 451 which is within the time 309 where the RF chain is between cell reselection for the GSM and LTE networks (e.g., second RATs). During time 451 the 1× network (first RAT) may update its timing information by reacquiring the network or pilot signal. A possible benefit of using the forced wakeup or timing information update outside the regularly scheduled first RAT page decode times is that the first RAT time tracking stays accurate enough for high fidelity time tracking during a full page decode at times 305. Additionally, the power consumed during the forced wakeup times (e.g., 450, 451, 452, 453) may be less than the full page decodes at times 305. Moreover, during the forced wake-ups at times 450, 451, 452, 453, the first RAT may perform timing information updates. The timing information update may comprise performing timing adjustments without performing a full page decode. In some embodiments, the timing information update may comprise reacquiring a pilot signal. The UE may then sync its time with the pilot signal. In such a way, the first RAT (1×) may avoid a system restart and may improve paging performance.

In some embodiments, the UE may not schedule the forced wake-ups for the first RAT until the first RAT has failed to access the RF chain for a certain amount of time or for a certain number of attempts. While the forced wake-ups shown in FIG. 4 are shown as occurring between each gap of the second RAT cell reselection or access, the forced wake-ups may occurs more or less frequently or may be scheduled dynamically. In some embodiments, the forced wake-up times may be scheduled based on the RF chain denial of the first RAT attempts to perform a full page decode. For example, the frequency of forced wake-ups may increase as the number of failed attempts to access the RF chain increases.

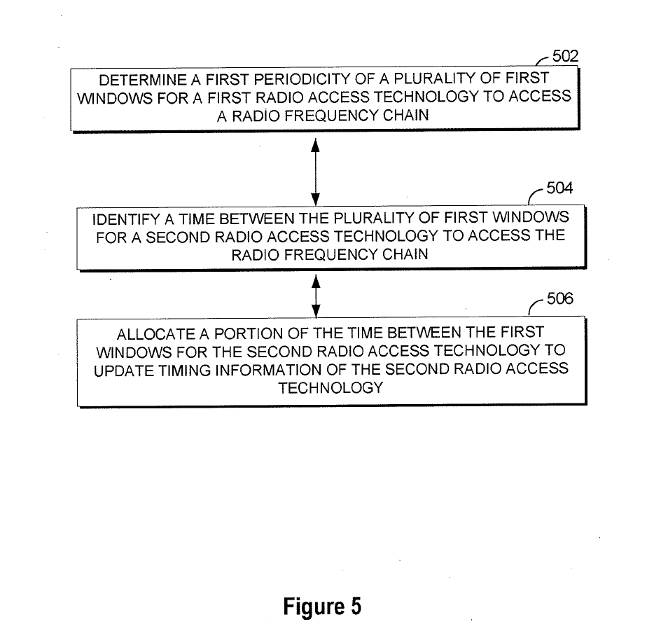

FIG. 5 is a flow chart of an exemplary method 500 for updating system timing information. In certain embodiments, the method 500 can be performed by a wireless device 202, such as but not limited to a processor 204, DSP 220, and a transmitter 210 of a wireless device 202. Although the method 500 in FIG. 5 is illustrated in a particular order, in certain embodiments the blocks herein may be performed in a different order, or omitted, and additional blocks can be added. A person of ordinary skill in the art will appreciate that the process of the illustrated embodiment may be implemented in any wireless device that can be configured to process and transmit a generated message.

At operation block 502, a wireless device 202 may determine a first periodicity of a plurality of first windows for a first radio access technology to access a radio frequency chain. At block 504, the wireless device 202 may identify a time between the plurality of first windows for a second radio access technology to access the radio frequency chain. At block 506, the wireless device 202 may allocate a portion of the time between the first windows for the second radio access technology to update timing information of the second radio access technology.

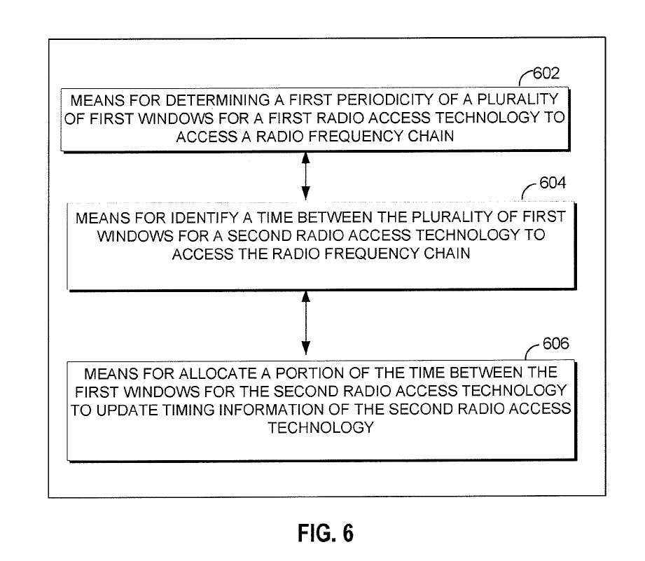

FIG. 6 is a functional block diagram of an apparatus 600 that can be employed to perform a method of FIG. 5 in the wireless communication system of FIG. 1. Those skilled in the art will appreciate that the apparatus 600 may have more components than the simplified block diagrams shown in FIG. 6. FIG. 6 includes only those components useful for describing some prominent features of implementations within the scope of the claims.

The apparatus 600 can include means 602 for determining a first periodicity of a plurality of first windows for a first radio access technology to access a radio frequency chain. In certain embodiments, the means 602 for determining can be configured to perform one or more of the functions with respect to block 502 (FIG. 5). In various embodiments, the means 602 for determining can be implemented by a processor 204 or DSP 220 (FIG. 2). In some embodiments, the means 602 for determining may comprise a set of steps performed on a general purpose computer. For example, the computer may receive a plurality of messages according to a periodicity. During the reception of the plurality of messages the computer determines that the RF chain is occupied. The computer may then determine portions of time between the reception of the plurality of messages when the RF chain is free. The computer may then determine that at least some of the portion of time between receptions may be granted to a first radio access technology.

The apparatus 600 further includes means 604 for identifying a time between the plurality of first windows for a second radio access technology to access the radio frequency chain. In certain embodiments, the means 604 for identifying can be configured to perform one or more of the functions described above with respect to block 504 (FIG. 5). In various embodiments, the means 604 for identifying can be implemented by a processor 204 or DSP 220 (FIG. 2). In some embodiments, the means 604 for identifying may comprise a set of steps performed on a general purpose computer. For example, the computer may receive a plurality of messages according to a periodicity. During the reception of the plurality of messages the computer determines that the RF chain is occupied. The computer may then determine portions of time between the reception of the plurality of messages when the RF chain is free. The computer may then determine that at least some of the portion of time between receptions may be granted to a second radio access technology.

The apparatus 600 further includes means 606 for allocating a portion of the time between the first windows for the second radio access technology to update timing information of the second radio access technology. In certain embodiments, the means 606 for allocating can be configured to perform one or more of the functions described above with respect to block 506 (FIG. 5). In various embodiments, the means 606 for monitoring can be implemented by a processor 204 or DSP 220 (FIG. 2). In some embodiments, the means 606 for allocating may comprise a set of steps performed on a general purpose computer. For example, the computer may receive a request from the second radio access technology to access an RF chain during the portion of time when the RF chain is free. The computer may then send a response message to the second radio access technology granting the request to access the RF chain.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

In some aspects, wireless signals may be transmitted utilizing various broadband wireless communication systems, including communication systems that are based on an orthogonal multiplexing scheme. Examples of such communication systems include Spatial Division Multiple Access (SDMA), Time Division Multiple Access (TDMA), Orthogonal Frequency Division Multiple Access (OFDMA) systems, Single-Carrier Frequency Division Multiple Access (SC-FDMA) systems, and so forth. An SDMA system may utilize sufficiently different directions to concurrently transmit data belonging to multiple user terminals. A TDMA system may allow multiple user terminals to share the

Various modifications to the implementations described in this disclosure can be readily apparent to those skilled in the art, and the generic principles defined herein can be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations.

Certain features that are described in this specification in the context of separate implementations also can be implemented in combination in a single implementation. Conversely, various features that are described in the context of a single implementation also can be implemented in multiple implementations separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

As used herein, a phrase referring to “at least one of” a list of items refers to any combination of those items, including single members. As an example, “at least one of: a, b, or c” is intended to cover: a, b, c, a-b, a-c, b-c, and a-b-c.

The terms “first” and “second” are used herein to distinguish among various elements (e.g., “first RAT” and “second RAT”) and are not intended to denote any particular order to these elements. The detailed description includes specific details for the purpose of providing a thorough understanding of the exemplary embodiments of the invention. In some instances, some devices are shown in block diagram form.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

While the foregoing is directed to aspects of the present disclosure, other and further aspects of the disclosure may be devised without departing from the basic scope thereof, and the scope thereof is determined by the claims that follow.

What is claimed is:

1. A method for updating system timing information comprising:
determining a first periodicity of a plurality of first windows for a first radio access technology of a user equipment to access a radio frequency chain of the user equipment;
identifying a time between the plurality of first windows for a second radio access technology of the user equipment to access the radio frequency chain; and
allocating a portion of the time between the first windows for the second radio access technology to update timing information of the second radio access technology.

2. The method of claim 1, further comprising updating timing information for the first radio access technology between the first windows.

3. The method of claim 1, wherein allocating the portion of time comprises allocating the portion of the time between the plurality of first windows when the second radio access technology fails to access the radio frequency chain for a period of time.

4. The method of claim 1, wherein allocating the portion of time comprises allocating the portion of the time between the plurality of first windows when the second radio access technology fails to access the radio frequency chain after a number of attempts to access the radio frequency chain.

5. The method of claim 1, further comprising:
determining a second periodicity of a plurality of second windows for the second radio access technology; and
selectively allocating a second portion of time between the plurality of second windows for the second radio access technology to update timing information, wherein the second portion of time comprises a time within the time between the first windows.

6. The method of claim 5, wherein selectively allocating the second portion comprises allocating the second portion based the second radio access technology failing to access the radio frequency chain.

7. The method of claim 5, wherein selectively allocating the second portion comprises allocating the second portion when the second radio access technology fails to access the radio frequency chain for a period of time or for a number of attempts to access the radio frequency chain.

8. The method of claim 5, wherein selectively allocating the second portion comprises allocating the second portion in response to a request from the second radio access technology to access the radio frequency chain.

9. The method of claim 1, further comprising scheduling access to the radio frequency chain based on a priority, the first radio access technology having a higher priority than the second radio access technology.

10. An apparatus for wireless communication, comprising:
a radio frequency chain;
a first subscriber identity module (SIM) providing a first radio access technology;
a second subscriber identity module (SIM) providing a second radio access technology;
a processor configured to:
determine a first periodicity of a plurality of first windows for the first radio access technology to access the radio frequency chain;
identify a time between the plurality of first windows for the second radio access technology to access the radio frequency chain; and
allocate a portion of the time between the first windows for the second radio access technology to update timing information of the second radio access technology.

11. The apparatus of claim 10, wherein the processor is further configured to update timing information for the first radio access technology between the first windows.

12. The apparatus of claim 10, wherein the processor is further configured to allocate the portion of the time between the plurality of first windows when the second radio access technology fails to access the radio frequency chain for a period of time or after a number of attempts to access the radio frequency chain.

13. The apparatus of claim 10, wherein the processor is further configured to:
determine a second periodicity of a plurality of second windows for the second radio access technology; and
selectively allocate a second portion of time between the plurality of second windows for the second radio access technology to update timing information, wherein the second portion of time comprises a time within the time between the first windows.

14. The apparatus of claim 13, wherein the processor is further configured to allocate the second portion based the second radio access technology failing to access the radio frequency chain

15. The apparatus of claim 13, wherein the processor is further configured to allocate the second portion when the second radio access technology fails to access the radio frequency chain for a period of time or for a number of attempts to access the radio frequency chain.

16. The apparatus of claim 13, wherein the processor is further configured to allocate the second portion in response to a request to access the radio frequency chain.

17. The apparatus of claim 10, wherein the processor is further configured to schedule access to the radio frequency chain based on a priority, the first radio access technology having a higher priority than the second radio access technology.

18. The apparatus of claim 10, wherein the first radio access technology comprises a cdma2000 1× technology, wherein the second radio access technology comprises a global system for mobile communications (GSM), a long term evolution (LTE), high data rate (HDR), 3^{rd} generation (3G), or 4^{th} generation (4G) technology.

19. An apparatus for wireless communication, comprising:
means for communicating over a first radio access technology;
means for communicating over a second radio access technology;
means for determining a first periodicity of a plurality of first windows for the first radio access technology to access a radio frequency chain of the apparatus;
means for identifying a time between the plurality of first windows for the second radio access technology to access the radio frequency chain; and
means for allocating a portion of the time between the first windows for the second radio access technology to update timing information of the second radio access technology.

20. The apparatus of claim 19, wherein the allocating means comprises means for allocating the portion of the time between the plurality of first windows when the second radio access technology fails to access the radio frequency chain for a period of time or after a number of attempts to access the radio frequency chain.

21. The apparatus of claim 19, further comprising:
means for determining a second periodicity of a plurality of second windows for the second radio access technology; and
means for selectively allocating a second portion of time between the plurality of second windows for the second radio access technology to update timing information, wherein the second portion of time comprises a time within the time between the first windows.

22. The apparatus of claim 21, wherein the means for selectively allocating comprises means for allocating the second portion based the second radio access technology failing to access the radio frequency chain.

23. The apparatus of claim 21, wherein the means for selectively allocating comprises means for allocating the second portion when the second radio access technology fails to access the radio frequency chain for a period of time or for a number of attempts to access the radio frequency chain.

24. The apparatus of claim 21, wherein the means for selectively allocating comprises means for allocating the second portion in response to a request to access the radio frequency chain.

25. The apparatus of claim 21, further comprising means for scheduling access to the radio frequency chain based on a priority, the first radio access technology having a higher priority than the second radio access technology.

26. A non-transitory computer-readable medium comprising code that, when executed, causes a processor to:
determine a first periodicity of a plurality of first windows for a first radio access technology of a user equipment to access a radio frequency chain of the user equipment;
identify a time between the plurality of first windows for a second radio access technology of the user equipment to access the radio frequency chain; and
allocate a portion of the time between the first windows for the second radio access technology to update timing information of the second radio access technology.

27. The medium of claim 26 wherein the code, when executed, causes the processor to allocate the portion of the time between the plurality of first windows when the second radio access technology fails to access the radio frequency chain for a period of time or after a number of attempts to access the radio frequency chain.

28. The medium of claim 26 wherein the code, when executed, causes the processor to:
determine a second periodicity of a plurality of second windows for the second radio access technology; and
selectively allocate a second portion of time between the plurality of second windows for the second radio access technology to update timing information, wherein the second portion of time comprises a time within the time between the first windows.

29. The medium of claim 28 wherein the code, when executed, causes the processor to allocate the second portion based the second radio access technology failing to access the radio frequency chain.

30. The medium of claim 28 wherein the code, when executed, causes the processor to allocate the second portion in response to a request to access the radio frequency chain.
